(19) United States
(12) Patent Application Publication
(10) Pub. No.: US 2023/0001496 A1
(43) Pub. Date: Jan. 5, 2023

(54) CIRCULAR SAW BLADE HOLDER

(71) Applicant: MILWAUKEE ELECTRIC TOOL CORPORATION, Brookfield, WI (US)

(72) Inventors: Glenn L. Meyers, Greenfield, WI (US); Aaron R. Check, Hartford, WI (US)

(21) Appl. No.: 17/781,496

(22) PCT Filed: Dec. 2, 2020
(86) PCT No.: PCT/US2020/062776

§ 371 Date: Jun. 1, 2022

Related U.S. Application Data
(60) Provisional application No. 62/944,136, filed on Dec. 5, 2019.

(51) Int. Cl. B23D 61/10; B23D 61/02

(52) U.S. Cl. CPC B23D 61/10; B23D 61/025

(57) ABSTRACT

A saw blade holder for a saw blade having a central aperture. The saw blade holder includes a base, a blade mount extending from the base, and a retaining member removably coupled to the blade mount for retaining the saw blade on the blade mount. The blade mount is configured to be received in the central aperture of the circular saw blade. At least a portion of the blade mount is flexible. The retaining member is removable from the blade mount and reusable.

### CROSS-REFERENCE TO RELATED APPLICATIONS

This application claims priority to U.S. Provisional Patent Application No. 62/944,136, filed Dec. 5, 2019, the entire contents of which are incorporated by reference herein.

### BACKGROUND

The present invention relates to holders for displaying articles and, more particularly, to holders for storing or displaying circular saw blades.

Generally, circular saw blades may be displayed on a holder within a packaging for merchandising purposes and for other various reasons. The packaging may inhibit a potential purchaser from contacting the saw blade and/or allow the saw blade to hang from a merchandise rack.

### SUMMARY

In one embodiment, the invention provides a saw blade holder for a circular saw blade having a central aperture. The saw blade holder includes a base and a blade mount extending from the base. The blade mount is configured to be received in the central aperture of the circular saw blade. At least a portion of the blade mount is flexible. The saw blade holder also includes a retaining member removably coupled to the blade mount for retaining the circular saw blade on the blade mount. The retaining member is removable from the blade mount and reusable.

In another embodiment, the invention provides a saw blade holder for a circular saw blade having a central aperture. The saw blade holder includes a base and a blade mount extending from the base in an axial direction. The blade mount is configured to be received in the central aperture of the circular saw blade. The saw blade holder also includes a retaining member removably coupled to the blade mount for retaining the circular saw blade on the blade mount. The retaining member is flexible in the axial direction to accommodate different thicknesses of circular saw blades.

In yet another embodiment, the invention provides a saw blade holder system including a circular saw blade having a body, a plurality of cutting teeth, and a central aperture. The body has a thickness measured in an axial direction. The saw blade holder system also includes a saw blade mount having a base and a blade mount extending from the base in the axial direction. The blade mount is received in the central aperture of the saw blade. At least a portion of the blade mount is flexible. The saw blade holder also has a retaining member removably coupled to the blade mount for retaining the circular saw blade on the blade mount. The retaining member is flexible in the axial direction to accommodate the thickness of the circular saw blade. The retaining member is removable from the blade mount and reusable.

Other aspects of the invention will become apparent by consideration of the detailed description and accompanying drawings.

### BRIEF DESCRIPTION OF THE DRAWINGS

FIG. 1 is a front view of a saw blade holder system including a circular saw blade and a saw blade holder according to an embodiment of the invention.

FIG. 2A is a perspective view of a base of the saw blade holder of FIG. 1.

FIG. 2B is a partial view of FIG. 2A magnifying a mount portion of the saw blade holder.

FIG. 3A is an isolated view of a reusable retaining member of the saw blade holder of FIG. 1.

FIG. 3B is a cross-sectional view of a reusable retaining member of the saw blade holder of FIG. 1, taken along line 3B-3B of FIG. 3A.

FIG. 4 is an exploded perspective view of the saw blade holder and two circular saw blades.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

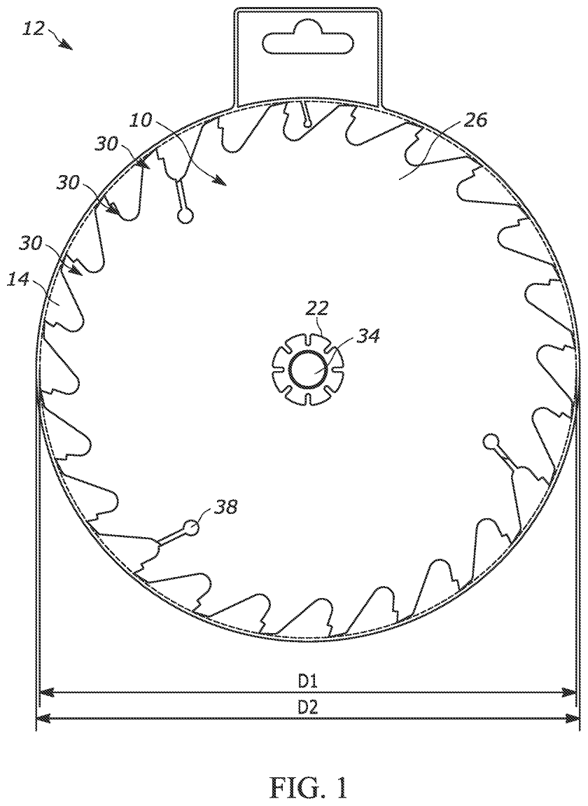

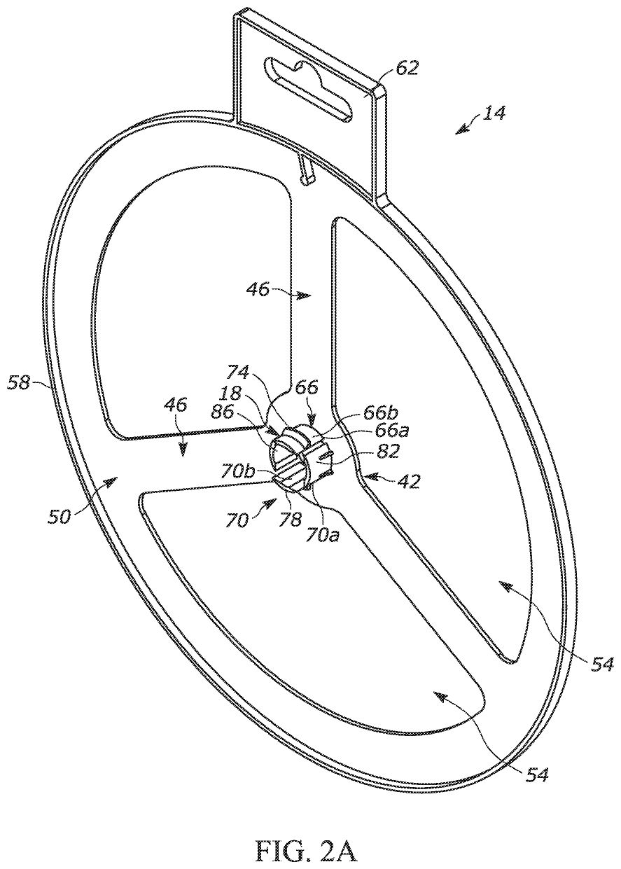

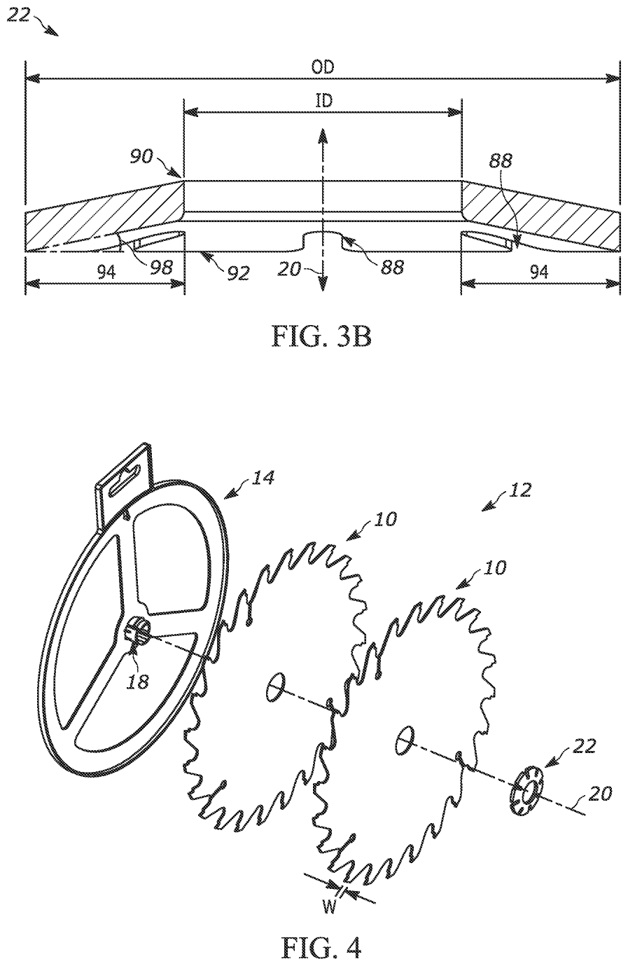

FIG. 1 illustrates a circular saw blade 10 and a saw blade holder 12. The blade holder 12 includes a base 14, a blade mount 18 (FIG. 2A) supported by the base 14, and a retaining member 22 removably coupled to the blade mount 18. The circular saw blade 10 has an outer diameter D1 and a thickness or width W (FIG. 4). The illustrated circular saw blade 10 includes a body 26, a plurality of cutting teeth 30, a central aperture 34, and at least one relief slot 38. In other embodiments, the circular saw blade 10 may have other configurations. The blade holder 12 also has a diameter D2 that is substantially similar to, but slightly larger than the diameter D1 of the saw blade 10. In other embodiments, the diameter D1 of the saw blade 10 and the diameter D2 of the blade holder 12 may have little to no similarity in size.

Referring to FIGS. 2A and 2B, the illustrated base 14 includes a hub 42, one or more spokes 46 extending from the hub 42, and a rim 50. The hub 42 is positioned substantially at the center of the base 14 and supports the saw blade mount 18. The spokes 46 extend radially outward from the hub 42 to the rim 50. A void 54 is defined between each pair of spokes 46 to reduce the amount of material needed to support the saw blade mount 18 on the base 14. In the illustrated embodiment, the base 14 includes three spokes 46 that extend from the hub 42 and three corresponding voids 54. The spokes 46 are equally spaced about the base 14. In other embodiments, the base 14 may include other numbers of spokes 46 and voids 54 and/or the spokes 46 may be unevenly spaced. Alternatively, the base 46 may be a monolithic disk that does not include the voids 54.

With continued reference to FIGS. 2A and 2B, the rim 50 includes a lip 58 around an outer circumference of the rim 50. The lip 58 extends in an axial direction 20 (FIG. 4) away from the rim 50. In some embodiments, the lip 58 may extend a distance equal to at least the width W (FIG. 4) of the saw blade 10. The lip 58 may help cover and radially constrain the saw blade 10 while the saw blade 10 is held on the holder 12. The base 14 further includes at least one hang tab 62 that projects from the rim 50. The hang tab 62 may be used to hang the holder 12. The holder 12 may be hung for a number of reasons. Such reasons may include hanging the holder 12 to display the saw blade 10 during merchandising or hanging the holder 12 to store the saw blade 10 at home or in a workshop. In the illustrated embodiment, the hang tab 62 is integrally formed with the remainder of the base 14. In other embodiments, the hang tab 62 may be a separate piece that is permanently or removably coupled to the rim 50.

With further reference to FIGS. 2A and 2B, the blade mount 18 extends away from the base 14. The blade mount 18 is configured to be received in the central aperture 34 (FIG. 1) of the circular saw blade 10. The blade mount 18 supports the circular saw blade 10 on the holder 12. The illustrated blade mount 18 includes a first flexible wall 66 and a second flexible wall 70. The flexible walls 66, 70 each include a base 66a, 70a and a body 66b, 70b and are positioned across from one another. The flexible walls 66, 70 are connected to the hub 42 at the bases 66a, 70a such that the bodies 66b, 70b are movable (e.g., elastically deformable) toward one another. In other words, a user may pinch the flexible walls 66, 70 together for the mount 18 to receive the central aperture 34 of the saw blade 10. Similarly, the user may pinch the flexible walls 66, 70 together to remove the saw blade 10 from the mount 18. Each of the flexible walls 66, 70 include a flange 74, 78 that assists to retain the saw blade 10 to the mount 18. The flanges 74, 78 are ramped on one side to provide a slip surface and flat on another side to provide a retaining surface. The flexible walls 66, 70 may also be deformed toward one another by pressing the central aperture 34 of the saw blade 10 against the ramped portion of the flanges 74, 78. The mount 18 further includes a first rigid wall 82 and a second rigid wall 86 that are also constrained to the hub 42. The rigid walls 82, 86 are positioned across from one another and adjacent to the flexible walls 66, 70. The flexible walls 66, 70 and rigid walls 82, 86 are curved and arranged relative one another to form a complimentary surface with the central aperture 34.

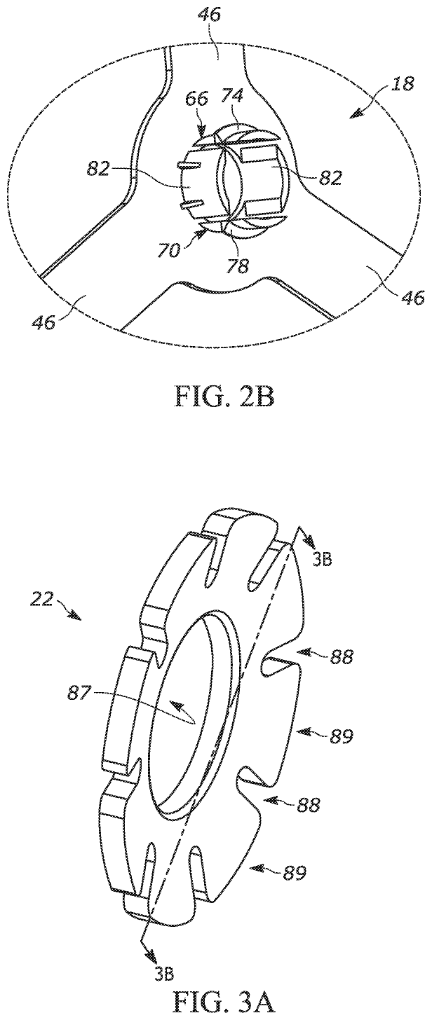

Referring now to FIGS. 3A and 3B, the retaining member 22 may be received on the saw blade mount 18 to retain the saw blade 10 to the holder 12. The illustrated retaining member 22 is a generally annular member having an overall cross-section that is larger than the central aperture 34. The illustrated retaining member 22 is also reusable and may be referred to as a reusable retaining member. In some embodiments, the retaining member 22 may be referred to as a reusable washer or a washer. The retaining member 22 has a central opening 87 that receives the blade mount 18. The illustrated central opening 87 is circular to generally match the shape and size of the blade mount 18. In the illustrated embodiment, the retaining member 22 also includes a plurality of radial slots or cutouts 88 formed in a perimeter of the retaining member 22. The radial slots 88 divide an outer perimeter of the retaining member 22 into separate lobes 89 and increase the flexibility of the retaining member 22. The retaining member 22 may be fitted to the blade mount 18 after the flexible walls 66, 70 (FIG. 2B) are pinched together. The flexible walls 66, 70 may also be deformed toward one another by pressing the retaining member 22 against the ramped portion of the flanges 74, 78. In the illustrated embodiment, the retaining member 22 may be placed on the blade mount 18 after one circular saw blade 10 is coupled to the blade mount 18 (as shown in FIG. 1) or after multiple circular saw blades 10 are coupled to the blade mount 18 (as shown in FIG. 4).

With specific reference to FIG. 3B, the retaining member 22 may be elastically flexible in the axial direction 20. The retaining member 22 includes an inner diameter ID and an overall outer diameter OD. The retaining member 22 defines a first or upper portion 90 at the inner diameter ID and a second or lower portion 92 at the outer diameter OD. The upper portion 90 may be slightly offset from the lower portion 92 (e.g., raised as viewed in FIG. 3B). An inner surface that defines the central opening 87 in the upper portion 90 may contact or bear against the flanges 74, and the lower portion 92 may contact the saw blade 10. FIG. 3B illustrates an elevation region 94 of the retaining member 22. Within the elevation region 94, the retaining member 22 rises from the lower portion 92 at outer diameter OD to the upper portion 90 at inner diameter ID. Such a rise allows the retaining member 22 to deform elastically in the axial direction 20 such that an angle 98 of the elevation region 94 may change as the retaining member 22 is being deformed or flexed. Such a rise also allows the retaining member 22 to flex or compress to fill a space between the flanges 74 and the saw blade 10. The space between the flanges 74 and the saw blade 10 may change depending on the width W of the saw blade 10 or the number of saw blades 10 that are being supported on the mount 18. In other words, the retaining member 22 may flex or compress to retain a number of saw blades having different widths to the holder 12, even if there is only one saw blade. The retaining member 22 also includes radially spaced relief cutouts 88. The cutouts 88 allow the retaining member 22 to deform elastically in a radial direction.

The retaining member 22 may be formed of an elastically flexible material that also maintains rigidity to constrain at least one saw blade 10 on the blade mount 18. In some embodiments, the retaining member 22 may be made of plastic. In other embodiments, the retaining member 22 may be made of other suitable materials, such as metal or a composite material. As such, the retaining member 22 is also reusable. That is, the retaining member 22 may be removed from the blade mount 18 without cutting, breaking, or otherwise destroying the retaining member 22. The retaining member 22 may, therefore, be reconnected to the blade mount 18 after the circular saw blade 10 is removed and recoupled to the blade mount 18 for storage. The retaining member 22 may also be connected to another blade mount on a similar holder, if desired.

The inner diameter ID across the central opening 87 of the retaining member 22 may be any dimension suitable to receive the blade mount 18. The overall size of the blade mount 18 may be sized to correspond with a size of the central aperture 34 of the saw blade 10 such that the retaining member 22 and blade holder 12 could have different dimensions to display/retain a saw blade of a larger or smaller diameter Dl. Likewise, the outer diameter OD of the retaining member 22 may be increased to reduce the elastic deformity of the retaining member 22 to thereby retain a larger saw blade 10 (e.g., saw blade with a greater width W, saw blade with larger outer diameter D1, heavier saw blade, etc.).

In some embodiments, the holder 12 and the circular saw blade 10 may be covered in a packaging material while the holder 12 is packaged and on display. The packaging material may be a transparent material (e.g., plastic shrink-wrap) that at least partially surrounds the saw blade 10 and the holder 12.

FIG. 4 illustrates multiple saw blades 10 that may be supported on the saw blade mount 18 and retained on the mount 18 by the retaining member 22. The pinch-fit of the saw blade 10 and retaining member 22 on the mount 18 allows the holder 12 to be reusable for holding the saw blade 10. In the illustrated embodiment, the holder 12 is configured to hold two of the same saw blades 10. In other embodiments, the holder 12 is configured to hold saw blades 10 having different dimensions and features (i.e., number of teeth, pitch of teeth, etc.). Therefore, the holder 12 may be used to display saw blades 10 and re-used to store saw blades 10 over any desired period of time.

Although the invention has been described in detail with reference to certain preferred embodiments, variations and modifications exist within the scope and spirit of one or more independent aspects of the invention as described. Various features and advantages of the invention are set forth in the following claims.

1. A saw blade holder for a circular saw blade, the circular saw blade having a central aperture, the saw blade holder comprising:
a base;
a blade mount extending from the base, the blade mount configured to be received in the central aperture of the circular saw blade, at least a portion of the blade mount being flexible; and
a retaining member removably coupled to the blade mount for retaining the circular saw blade on the blade mount, the retaining member being removable from the blade mount and reusable.

2. The saw blade holder of claim 1, wherein the blade mount includes a flexible wall and a rigid wall, and wherein the flexible wall is deformable relative to the rigid wall to facilitate removal of the circular saw blade from the blade mount.

3. The saw blade holder of claim 2, wherein the flexible wall includes an outwardly extending flange, the outwardly extending flange being ramped on one side to facilitate inserting the circular saw blade onto the blade mount and being flat on another side to inhibit removal of the circular saw blade from the blade mount.

4. The saw blade holder of claim 2, wherein the flexible wall is a first flexible wall and the rigid wall is a first rigid wall, wherein the blade mount also includes a second flexible wall and a second rigid wall, and wherein the first and second flexible walls are deformable relative to the first and second rigid walls to facilitate removal of the circular saw blade from the blade mount.

5. The saw blade holder of claim 4, wherein the first flexible wall, the second flexible wall, the first rigid wall, and the second rigid wall are arranged in a circle.

6. The saw blade holder of claim 1, wherein the base includes
a hub substantially at a center of the base,
one or more spokes extending radially from the hub, and
a rim surrounding the hub and coupled to the one or more spokes.

7. The saw blade holder of claim 6, wherein the rim includes a lip around an outer circumference of the rim, and wherein the lip extends in an axial direction from the rim.

8. The saw blade holder of claim 6, wherein the base includes a tab projecting from the rim, and wherein the tab is configured to hang the saw blade holder.

9. The saw blade holder of claim 1, wherein the blade mount extends from the base in an axial direction, and wherein the retaining member is flexible in the axial direction to accommodate different thicknesses of circular saw blades.

10. The saw blade holder of claim 9, wherein the retaining member includes a first portion defining an inner diameter and a second portion defining an outer diameter, and wherein the first portion is offset from the second portion.

11. The saw blade holder of claim 9, wherein the retaining member includes a plurality of radial slots formed in a perimeter of the retaining member.

12. A saw blade holder for a circular saw blade, the circular saw blade having a central aperture, the saw blade holder comprising:
a base;
a blade mount extending from the base in an axial direction, the blade mount configured to be received in the central aperture of the circular saw blade; and
a retaining member removably coupled to the blade mount for retaining the circular saw blade on the blade mount, the retaining member being flexible in the axial direction to accommodate different thicknesses of circular saw blades.

13. The saw blade holder of claim 12, wherein the base includes
a hub substantially at a center of the base,
one or more spokes extending radially from the hub, and
a rim surrounding the hub and coupled to the one or more spokes.

14. The saw blade holder of claim 13, wherein the rim includes a lip around an outer circumference of the rim, and wherein the lip extends in an axial direction from the rim.

15. The saw blade holder of claim 13, wherein the base includes a tab projecting from the rim, and wherein the tab is configured to hang the saw blade holder.

16. The saw blade holder of claim 12, wherein the retaining member includes a first portion defining an inner diameter and a second portion defining an outer diameter, and wherein the first portion is offset from the second portion.

17. The saw blade holder of claim 12, wherein the retaining member includes a plurality of radial slots formed in a perimeter of the retaining member.

18. A saw blade holder system comprising:
a circular saw blade including a body, a plurality of cutting teeth, and a central aperture, the body having a thickness measured in an axial direction; and
a saw blade holder including
a base,
a blade mount extending from the base in the axial direction, the blade mount received in the central aperture of the saw blade, at least a portion of the blade mount being flexible, and
a retaining member removably coupled to the blade mount for retaining the circular saw blade on the blade mount, the retaining member being flexible in the axial direction to accommodate the thickness of the circular saw blade, the retaining member being removable from the blade mount and reusable.

19. The saw blade holder system of claim 18, wherein the base includes
a hub substantially at a center of the base,
one or more spokes extending radially from the hub, and
a rim surrounding the hub and coupled to the one or more spokes.

20. The saw blade holder system of claim 18, wherein the retaining member includes a first portion defining an inner diameter, a second portion defining an outer diameter, and a plurality of radial slots formed in the second portion, and wherein the first portion is offset from the second portion.
